(19) United States
(12) Patent Application Publication
(10) Pub. No.: US 2012/0327778 A1
(43) Pub. Date: Dec. 27, 2012

(54) SYSTEMS AND METHODS FOR PRIORITIZING AND SCHEDULING PACKETS IN A COMMUNICATION NETWORK

(75) Inventors: Kenneth Stanwood, Vista, CA (US); David Gell, San Diego, CA (US)

(73) Assignee: CYGNUS BROADBAND, INC., San Diego, CA (US)

(21) Appl. No.: 13/166,660

(22) Filed: Jun. 22, 2011

(51) Int. Cl. H04W 72/06; H04W 28/02

(52) U.S. Cl. 370/237; 370/329

(57) ABSTRACT

Systems and methods for providing a weight-based scheduling system that incorporates end-user application awareness are provided and can be used with scheduling groups that contain data streams from heterogeneous applications. Individual data queues within a scheduling group can be created based on application class, specific application, individual data streams or some combination thereof. Application information and Application Factors (AF) are used to modify scheduler weights to differentiate between data streams assigned to a scheduling group. One embodiment adjusts the relative importance of different user applications using dynamic AF settings to maximize user Quality of Experience (QoE) in response to recurring network patterns, one-time events, or both. One embodiment maximizes user QoE for video applications by dynamically managing scheduling weights is provided that incorporates the notions of “duration neglect” and “recency effect” in an end-user's perception of video quality in order to optimally manage video traffic during periods of congestion.

### FIELD OF THE INVENTION

The present invention generally relates to the field of communication systems and more specifically to systems and methods for optimizing system performance through weight-based scheduling in capacity and spectrum constrained, multiple-access communication systems.

### BACKGROUND

In a communication network, such as an Internet Protocol (IP) network, each node and subnet has limitations on the amount of data which can be effectively transported at any given time. In a wired network, this is often a function of equipment capability. For example, a Gigabit Ethernet link can transport no more than 1 billion bits of traffic per second. In a wireless network the capacity is limited by the channel bandwidth, the transmission technology, and the communication protocols used. A wireless network is further constrained by the amount of spectrum allocated to a service area and the quality of the signal between the sending and receiving systems. Because these aspects can be dynamic, the capacity of a wireless system may vary over time.

### SUMMARY

Systems and methods for providing a weight-based scheduling system that incorporates end-user application awareness are provided. The systems and methods disclosed herein can include communication systems having scheduling groups that contain data streams from heterogeneous applications. Some embodiments use packet inspection to classify data traffic by end-user application. Individual data queues within a scheduling group can be created based on application class, specific application, individual data streams or some combination thereof. Embodiments use application information in conjunction with Application Factors (AF) to modify scheduler weights, thereby differentiating the treatment of data streams assigned to a scheduling group. In an embodiment, a method for adjusting the relative importance of different user applications through the use of dynamic AF settings is provided to maximize user Quality of Experience (QoE) in response to recurring network patterns, one-time events, or both.

In an embodiment, a method for maximizing user QoE for video applications by dynamically managing scheduling weights is provided. This method incorporates the notions of “duration neglect” and “recency effect” in an end-user's perception of video quality (i.e. video QoE) in order to optimally manage video traffic during periods of congestion.

According to an embodiment, a weight-based scheduling system for scheduling transmission of data packets in a wireless communication system is provided. The system includes a classification and queuing module, a weight calculation module, and a scheduler module. The classification and queuing module is configured to receive input traffic that includes data packets from a plurality of heterogeneous data streams. The classification and queuing module is also configured to analyze each data packet and assign the data packet to a scheduling group and data queue based on attributes of the packet. The classification and queuing module is further configured to output one or more data queues and classification information associated with the data packets in each of the one or more data queues. The weight calculation module is configured to receive the classification information from the classification and queuing module and to calculate weights for each of the one or more data queues and to output the calculated weights. The scheduler module configured to receive the one or more data queues from the classification and queuing module and to receive the calculated weights from the weight calculation module. The scheduler module is further configured to select data packets from the one or more data queues based on the calculated weights and to insert the selected data packets into an output queue for transmission over a physical communication layer.

According to an embodiment, a method for prioritizing and scheduling data packets in a communication network is provided. The method includes receiving a plurality of data packets; classifying the plurality of data packets; segregating the plurality of data packets into a plurality of scheduling groups; segregating the plurality of data packets to a plurality of data queues; determining weights to associate with each of the data queues. The weights are determined at least in part by application types associated with the data packets. The method further includes selecting data packets from the plurality of data queues based on the weights associated with the data queues; inserting the selected packets into an output data queue based on the weight associated with each of the data queues; and transmitting the plurality of data packets from the output data queue across a physical communication layer for transmission across a network communication medium.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a wireless communication network in which the systems and methods disclosed herein can be implemented according to an embodiment;

FIG. 2A is block diagram of another wireless communication network in which the systems and methods disclosed herein can be implemented according to an embodiment;

FIG. 2B is a functional block diagram of a station according to an embodiment;

FIG. 3 is a block diagram illustrating a weight-based scheduling system that can be used to implement weight-based scheduling techniques according to an embodiment;

FIG. 4A is a block diagram illustrating the relationship between heterogeneous input traffic and individual queues in a weight-based queuing system according to an embodiment;

FIG. 4B is a block diagram illustrating an enhanced packet inspection system for use in an enhanced classification/queuing module according to an embodiment;

FIG. 4C is a block diagram illustrating an enhanced packet inspection function for use in an enhanced classification/queuing module according to an embodiment;

FIG. 5 is a block diagram illustrating a wireless communication system according to an embodiment;

FIG. 6 is a table illustrating an example of a mapping between Application Classes and Specific Applications that can be used in the various techniques disclosed herein;

FIG. 7 is a block diagram illustrating an example of a RTSP packet encapsulated within a TCP/IP frame according to an embodiment;

FIG. 8 is a table illustrating sample AF assignments on per Application Class and per Specific Application basis according to an embodiment

FIG. 9 is a table illustrating enhanced weight factor calculations according to an embodiment;

FIG. 10 is a timing diagram that illustrates management of coefficients that can be used in the enhanced weight factor calculations disclosed herein;

FIG. 11 is a flow chart of a method for calculating enhanced weights according to an embodiment; and

FIG. 12 is a flow diagram of a method for queuing data packets to be transmitted across a network medium using a weight-based scheduling technique according to an embodiment.

### DETAILED DESCRIPTION

Systems and methods for providing a weight-based scheduling system that incorporates end-user application awareness are provided. The systems and methods disclosed herein can be used with scheduling groups that contain data streams from heterogeneous applications. Some embodiments use packet inspection to classify data traffic by end-user application. Individual data queues within a scheduling group can be created based on application class, specific application, individual data streams or some combination thereof. Embodiments use application information in conjunction with Application Factors (AF) to modify scheduler weights, thereby differentiating the treatment of data streams assigned to a scheduling group. In an embodiment, a method for adjusting the relative importance of different user applications through the use of dynamic AF settings is provided to maximize user QoE in response to recurring network patterns, one-time events, or both. In an embodiment, a method for maximizing user QoE for video applications by dynamically managing scheduling weights is provided. This method incorporates the notions of “duration neglect” and “recency effect” in an end-user's perception of video quality (i.e. video QoE) in order to optimally manage video traffic during periods of congestion.

The systems and methods disclosed herein can be applied to various capacity-limited communication systems, including but not limited to wireline and wireless technologies. For example, the systems and methods disclosed herein can be used with Cellular 2G, 3G, 4G (including Long Term Evolution (“LTE”), LTE Advanced, WiMax), WiFi, Ultra Mobile Broadband (“UMB”), cable modem, and other wireline or wireless technologies. Although the phrases and terms used herein to describe specific embodiments can be applied to a particular technology or standard, the systems and methods described herein are not limited to these specific standards.

### Basic Deployments

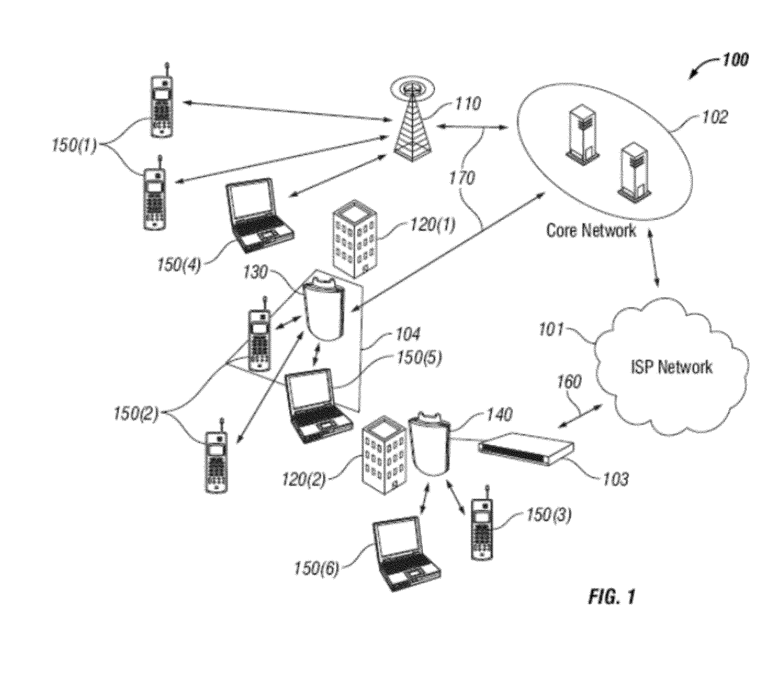

FIG. 1 is a block diagram of a wireless communication network in which the systems and methods disclosed herein can be implemented according to an embodiment. FIG. 1 illustrates a typical basic deployment of a communication system that includes macrocells, picocells, and enterprise femtocells. In a typical deployment, the macrocells can transmit and receive on one or many frequency channels that are separate from the one or many frequency channels used by the small form factor (SFF) base stations (including picocells and enterprise or residential femtocells). In other embodiments, the macrocells and the SFF base stations can share the same frequency channels. Various combinations of geography and channel availability can create a variety of interference scenarios that can impact the throughput of the communications system.

FIG. 1 illustrates an example of a typical picocell and enterprise femtocell deployment in a communications network 100. Macro base station 110 is connected to a core network 102 through a backhaul connection 170. Subscriber stations 150(1) and 150(4) can connect to the network through macro base station 110. In the network configuration illustrated in FIG. 1, office building 120(1) causes a coverage shadow 104. Pico station 130, which is connected to core network 102 via backhaul connection 170, can provide coverage to subscriber stations 150(2) and 150(5) in coverage shadow 104.

In office building 120(2), enterprise femtocell 140 provides in-building coverage to subscriber stations 150(3) and 150(6). Enterprise femtocell 140 can connect to core network 102 via ISP network 101 by utilizing broadband connection 160 provided by enterprise gateway 103.

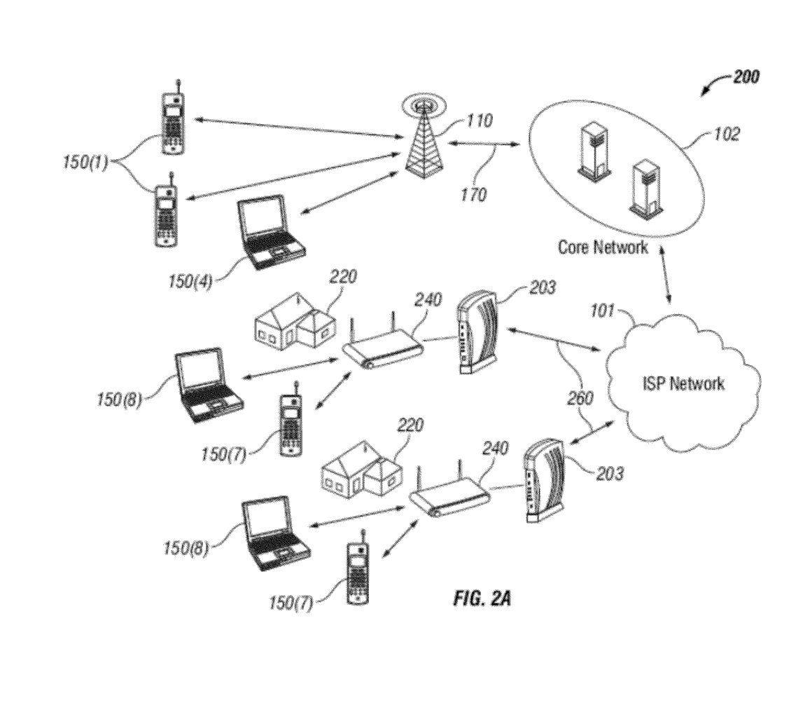

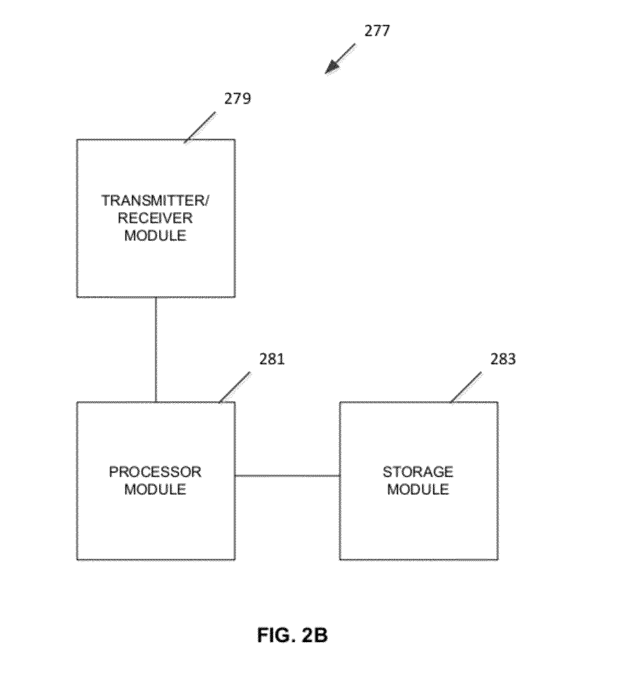

FIG. 2A is a block diagram of another wireless communication network in which the system and methods disclosed herein is implemented according to an embodiment. FIG. 2A illustrates a typical basic deployment in a communications network 200 that includes macrocells and residential femtocells deployed in a residential environment. Macrocell base station 110 is connected to core network 102 through backhaul connection 170. Subscriber stations 150(1) and 150(4) can connect to the network through macro base station 110. Inside residences 220, residential femtocell 240 can provide in-home coverage to subscriber stations 150(7) and 150(8). Residential femtocells 240 can connect to core network 102 via ISP network 101 by utilizing broadband connection 260 provided by cable modem or DSL modem 203.

Data networks (e.g. IP), in both wireline and wireless forms, have minimal capability to reserve capacity for a particular connection or user, and therefore demand may exceed capacity. This congestion effect may occur on both wired and wireless networks.

During periods of congestion, network devices must decide which data packets are allowed to travel on a network, i.e. which traffic is forwarded, delayed or discarded. In a simple case, data packets are added to a fixed length queue and sent on to the network as capacity allows. During times of network congestion, the fixed length queue may fill to capacity. Data packets that arrive when the queue is full are typically discarded until the queue is drained of enough data to allow queuing of more data packets. This first-in-first-out (FIFO) method has the disadvantage of treating all packets with equal fairness, regardless of user, application or urgency. This is an undesirable response as it ignores that each data stream can have unique packet delivery requirements, based upon the applications generating the traffic (e.g. voice, video, email, internet browsing, etc.). Different applications degrade in different manners and with differing severity due to packet delay and/or discard. Thus, a FIFO method is said to be incapable of managing traffic in order to maximize an end user's experience, often termed Quality of Experience (QoE).

In response, technologies have been developed to categorize packets and to treat data streams (defined herein as the stream of packets from a single, user application, for example a YouTube video) with differing levels of importance and/or to manage to differentiated levels of service.

FIG. 2B is a functional block diagram of a station 277. In some embodiments, the station 277 is a base station, an LTE eNB, a UE, a terminal device, a network switch a network router, a gateway, subscriber station, or other network node (e.g., the macro base station 110, pico station 130, enterprise femtocell 140, enterprise gateway 103, residential femtocell 240, cable modem or DSL modem 203, or subscriber stations 150 shown in FIGS. 1 and 2A). The station 277 comprises a processor module 281 communicatively coupled to a transmitter receiver module 279 and a to storage module 283. The transmitter receiver module 279 is configured to transmit and receive communications with other devices. In one embodiment, the communications are transmitted and received wirelessly. In another embodiment, the communications are transmitted and received over wire. In one embodiment, the transmitter receiver module includes an antenna and a radio. The processor module 281 is configured to process communications being received and transmitted by the station 277. The storage module 283 is configured to store data for use by the processor module 281. In some embodiments, the storage module 283 is also configured to store computer readable instructions for accomplishing the functionality described herein with respect to the station 277. In one embodiment, the storage module 283 includes a non-transitory compute readable medium. For the purpose of explanation, the station 277 or embodiments of it such as the base station, subscriber station, and femto cell, are described as having certain functionality. It will be appreciated that in some embodiments, this functionality is accomplished by the processor module 281 in conjunction with the storage module 283 and transmitter receiver module 279.

### Performance Requirements

One method to assign importance and to optimize resource allocation between different data streams is through the use of desired performance requirements. For example, performance requirements may include desired packet throughput, and tolerated latency and jitter. Such performance requirements may be assigned based upon the type of data or supported application. For example, a voice over internet protocol (VoIP) phone call may be assigned the following performance requirements suited for the packet based transmission of voice through an IP network: throughput=32 kilobits per second (kbps), maximum latency=100 milliseconds (mS), and maximum jitter=10 mS. In contrast, a data stream which carries video may require substantially more throughput, but may allow for slightly relaxed latency and jitter performance as follows: throughput=2 megabits per second (Mbps), maximum latency=300 mS, maximum jitter=60 mS.

Scheduling algorithms located at network nodes can use these performance requirements to make packet forwarding decisions in an attempt to best meet each stream's requirements. The sum total of a stream's performance requirements is often described as the quality of service, or QoS, requirements for the stream.

### Priority

Another method to assign importance is through the use of relative priority between different data streams. For example, standards such as the IEEE 802.1p and IETF RFC 2474 Diffserv define bits within the IP frame headers to carry such priority information. This information can be used by a network node's scheduling algorithm to make forwarding decisions, as is the case with the IEEE 802.11e wireless standard. Additional characteristics of a packet or data stream can also be mapped to a priority value, and passed to the scheduling algorithm. The standard 802.16e, for example, allows characteristics such as IP source/destination address or TCP/UDP port number to be mapped to a relative stream priority while also considering performance requirements such as throughput, latency, and jitter.

Scheduling Groups

In some systems, data streams may be assigned to a discrete number of scheduling groups, defined by one or more common characteristics of scheduling method, member data streams, scheduling requirements or some combination thereof.

For example, scheduling groups can be defined by the scheduling algorithm to be used on member data streams (e.g. scheduling group #1 may use a proportional fair algorithm, while scheduling group #2 uses a weighted round-robin algorithm).

Alternatively, a scheduling group may be used to group data streams of similar applications (e.g. voice, video or background data). For example, Cisco defines six groups to differentiate voice, video, signaling, background and other data streams. In the case of Cisco products, this differentiation of application may be combined with unique scheduling algorithms applied to each scheduling group.

In another example, the Third Generation Partnership Program (3GPP) has established a construct termed QoS Class Identifiers (QCI) for use in the Long Term Evolution (LTE) standard. The QCI system has 9 scheduling groups defined by a combination of performance requirements, scheduler priority and user application. For example, the scheduling group referenced by QCI index=1 is defined by the following characteristics:
(1) Performance Requirements: Latency=100 mS, Packet Loss Rate=10e-2, Guaranteed Bit Rate
(2) Priority: 2
(3) Application: Conversational Voice

The term ‘class of service’ (or CoS) is sometimes used as a synonym for scheduling groups.

### Weight-Based Scheduling Systems

In systems as described above, one or more data streams can be assigned an importance and a desired level of performance. This information may be used to assign packets from each data stream to a scheduling group and data queue. A scheduling algorithm can also use this information to decide which queues (and therefore which data streams and packets) to treat preferentially to others in both wired and wireless systems.

In some scheduling algorithms the importance and desired level of service of each queue is conveyed to the scheduler through the use of a scheduling weight. For example, weighted round robin (WRR) and weighted fair queuing (WFQ) scheduling methods both use weights to adjust service among data queues.

In WRR, all non-empty queues are serviced in each scheduling round, with the number of data packets served from each queue being proportional to the weight of the queue. In one example, three queues may have data pending. The queue weights are 1, 3 and 6 for queues 1, 2 and 3 respectively. If 20 packets are to be served during each round, then queues 1, 2 and 3 would be granted 10%, 30% and 60% of the 20 packet budget or 2, 6 and 12 packets, respectively. One skilled in the art will recognize that other weights can be applied as well.

The WFQ algorithm is similar to WRR in that weighted data queues are established and serviced in an effort to provide a level of fairness across data streams. In contrast to WRR, WFQ serves queues by looking at number of bytes served, rather than number of packets. WFQ works well in systems where data packets may be fragmented into a number of pieces or segments, such as in WiMAX systems.

Weights can be adjusted, round-by-round, in an effort to balance the performance requirements of multiple queues. For example, a queue which has been allocated resources below its minimum guaranteed bit rate (GBR) specification may have its weight increased in relation of another queue which has been allocated capacity substantially above its GBR.

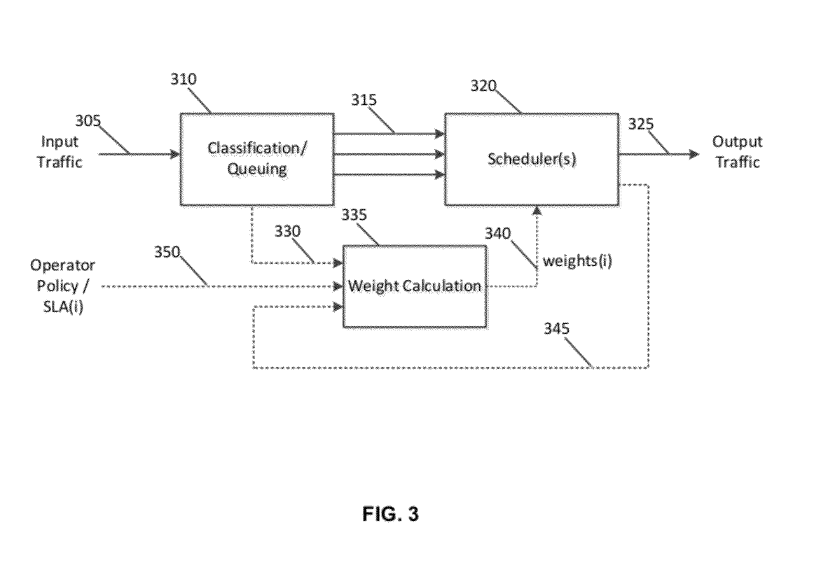

FIG. 3 is a block diagram illustrating a weight-based scheduling system that is used to implement the various weight-based scheduling techniques described above as well as the enhanced weight-based scheduling techniques described below according to an embodiment. The weight-based scheduling system illustrated in FIG. 3 can be implemented to use one or more scheduling groups. In one embodiment, the functionality described with respect to the features of FIG. 3 are implemented by the processor module 281 of FIG. 2B.

Input traffic 305 can consist of a heterogeneous set of individual data streams each with unique users, sessions, logical connections, performance requirements, priorities or policies and enters the scheduling system. Classification and queuing module 310 is configured to assess the relative importance and assigned performance requirements of each packet and to assign the packet to a scheduling group and data queue. According to an embodiment, the classification and queuing module 310 is configured to assess the relative importance and assigned performance requirements of each packet using one of the methods described above, such as 802.1p or Diffserv.

According to an embodiment, the weight-based scheduling system is implemented to use one or more scheduling groups and each scheduling group may have one or more data queues associated with the group. According to an embodiment, each scheduling group can include a different number of queues, and each scheduling group can use different methods for grouping packets into queues, or a combination thereof. A detailed description of the mapping between input traffic, scheduling groups and data queues is presented below.

According to an embodiment, classification and queuing module 310 outputs one or more data queues 315 and classification information 330 which is received as an input at weight calculation process module 335. The phrase “outputs one or more data queues” is intended to encompass populating the data queues and does not require actual transmission or transfer of the queues. According to an embodiment, the classification information 330 can include classifier results, packet size, packet quantity, and/or current queue utilization information. Weight calculation process module 335 is configured to calculate new weights on a per queue basis. Weight calculation process module 335 can be configured to calculate the new weights based on a various inputs, including the classification information 330, optional operator policy and service level agreement (SLA) information 350, and optional scheduler feedback information 345 (e.g., stream history received or resource utilization from scheduler module 320). Weight calculation process module 335 can then output weights 340 to one or more scheduler modules 320.

Scheduler module 320 receives the weights 340 and the data queues 315 (or accesses the data queues) output by classification and queuing module 310. Data queues as described herein can be implemented in various ways. For example, they can contain the actual data (e.g., packets) or merely pointers or identifiers of the data (packets). Scheduler module 320 uses the updated weights 340 to determine the order in which to forward packets (or fragments of packets) from the data queues 315 to output queue 325, for instance using one of the methods described above such as WRR or WFQ. The traffic in the output queue 325 is de-queued and fed to the physical communication layer (or ‘PHY’) for transmission on a wireless or wireline medium.

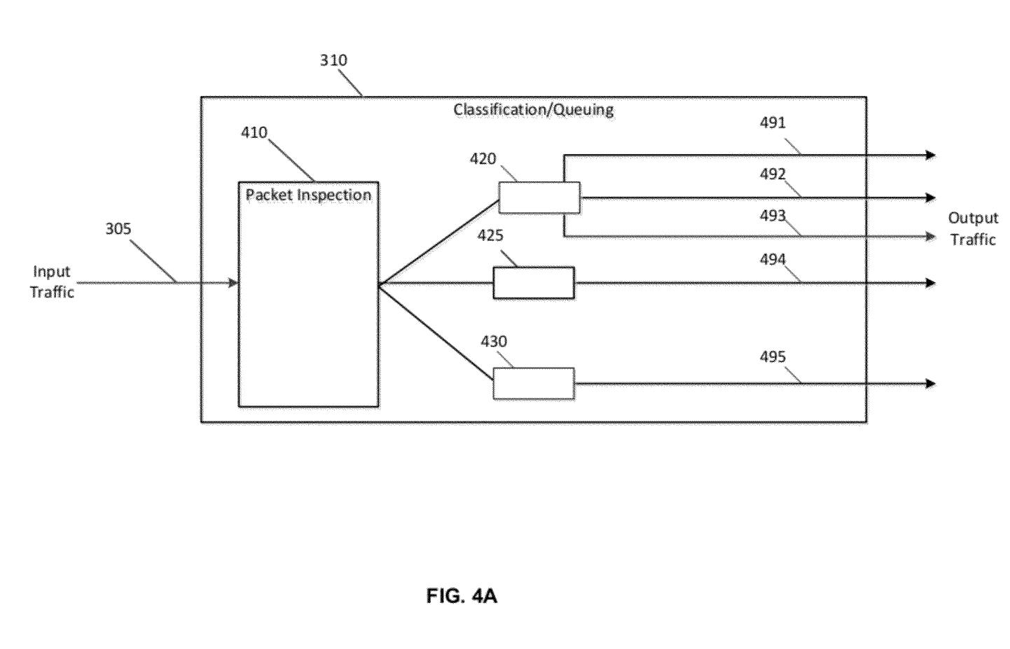

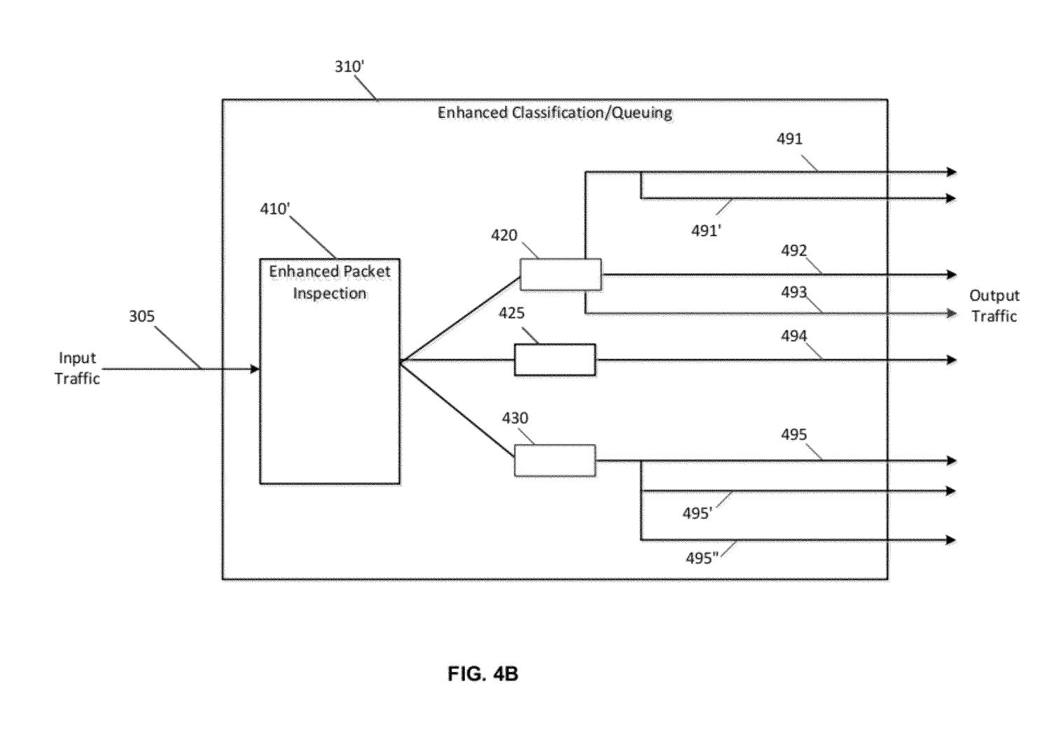

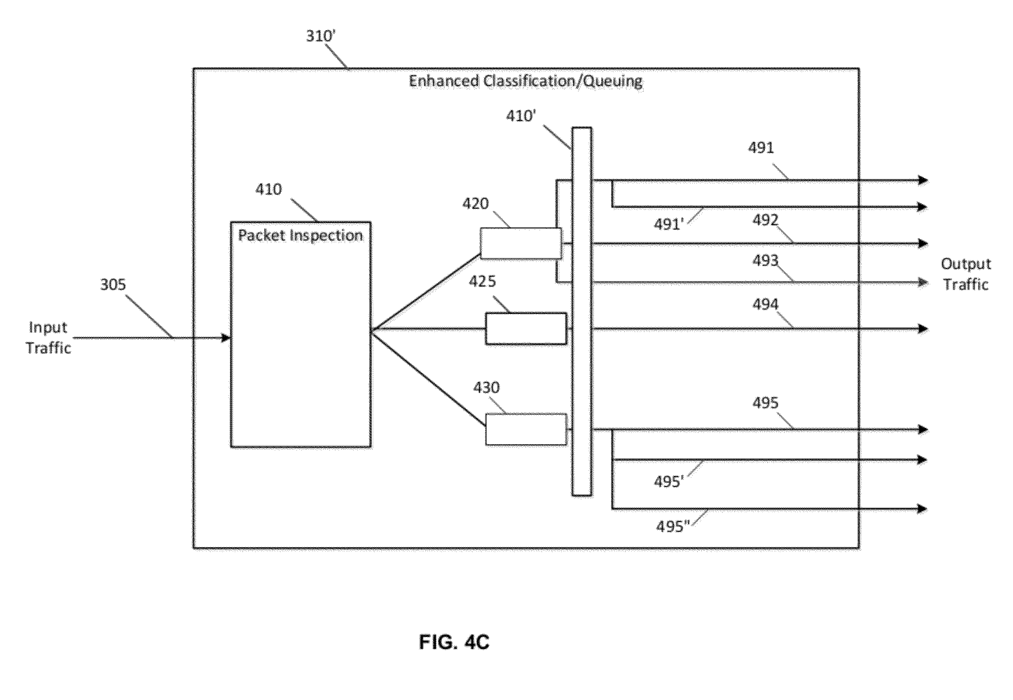

FIG. 4A is a block diagram illustrating the relationship between heterogeneous input traffic and individual queues in a weight-based queuing system. FIG. 4A illustrates the operation of classification and queuing module 310 illustrated in FIG. 3 in greater detail.

Heterogeneous input traffic 305 is input into packet inspection module 410 which characterizes each packet to assess performance requirements and priority as described above. Based upon this information, each packet is assigned one of three scheduling groups 420, 425 and 430. While the embodiment illustrated in FIG. 4A merely includes three scheduling groups, one skilled in the art will recognize that other embodiments may include a greater or lesser number of scheduling groups. The packets can then be assigned to a data queue (491, 492, 493, 494, or 495) associated with one of the scheduling groups. Packets can be assigned to a specific data queue associated with a scheduling group based on performance requirements, priority, additional user specific policy/SLA settings, unique logical connections or some combination thereof.

In one example, an LTE eNB is configured to assign each QCI to a separate scheduling group (e.g. packets with QCI=9 may be assigned to one scheduling group and packets with QCI=8 assigned to a different scheduling group). Furthermore, packets with QCI=9 may be assigned to individual queues based on user ID, bearer ID, SLA or some combination thereof For example, each LTE UE may have a default bearer and one or more dedicated bearers. Within the QCI=9 scheduling group, packets from default bearers may be assigned to one queue and packets from dedicated bearers may be assigned a different queue.

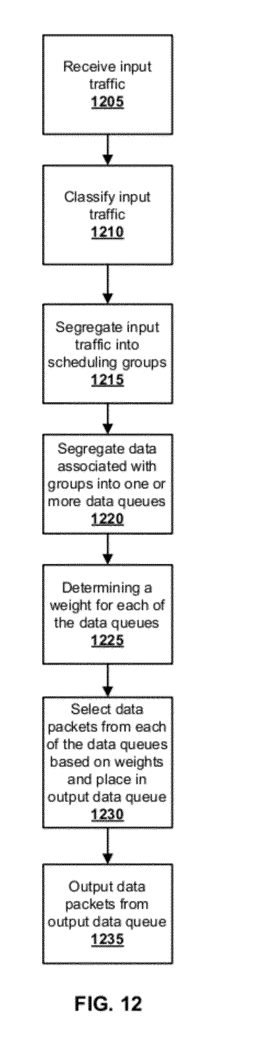

FIG. 12 is a flow diagram of a method for queuing data packets to be transmitted across a network medium using a weight-based scheduling technique according to an embodiment. The method illustrated in FIG. 12 can be implemented using the systems illustrated in FIGS. 3 and 4. According to an embodiment, the method illustrated in FIG. 12 is implemented using the various weight-based scheduling techniques described above as well as the enhanced weight-based scheduling techniques described below according to an embodiment.

The method begins with receiving input traffic to be scheduled to be transmitted across a network medium (step 1205). According to an embodiment, the network medium can be a wired or wireless medium. According to an embodiment, the input traffic is input traffic 305 described above. The input traffic can consist of a heterogeneous set of individual data streams each with unique users, sessions, logical connections, performance requirements, priorities or policies. According to an embodiment, classification and queuing module 310 can perform step 1205. According to an embodiment, packet inspection module 410 can perform this assessment step.

The input traffic can then be classified (step 1210). According to an embodiment, classification and queuing module 310 can perform step 1210. In this classification step, the input traffic is assessed to determine relative importance of each packet and to determine if performance requirements have been assigned for each data packet. According to an embodiment, packet inspection module 410 can perform this assessment step. This information can then be used by the classification and queuing module 310 to determine which scheduling groups the data packets should be added.

The input traffic can then be segregated into a plurality of scheduling groups (step 1215). The classification and queuing module 310 can use the information from the classification step to determine a scheduling group into which each data packet should be added. According to an embodiment, packet inspection module 410 of the classification and queuing module 310 can perform this step. According to an embodiment, the relative importance and assigned performance requirements of each packet is assessed using one of the methods described above, such as 802.1p or Diffserv.

The data packets comprising the input traffic can then be inserted into one or more data queues associated with the scheduling groups (step 1220). According to an embodiment, packet inspection module 410 of the classification and queuing module 310 can perform this step.

A weight can then be calculated for each of the data queues (step 1225). According to an embodiment, this step is implemented by weight calculation process module 335. The weight for each of the data queues is calculated based on the classification information created in step 1210. The classification information the classification information 330 can include classifier results, packet size, packet quantity, and/or current queue utilization information. The calculation of the weights can also take into account other inputs including optional operator policy and service level agreement (SLA) information and optional scheduler feedback information.

Once the data packets have been added to the queues, data packets can be selected from each of the queues based on weights associated with those queues and inserted into an output queue (step 1230). The data packets in the output queue can then be de-queued and fed to the physical communication layer (or ‘PHY’) for transmission on a wireless or wireline medium (step 1235). According to an embodiment, scheduler module 320 can implement steps 1230 and 1235 of this method.

### Deficiencies in Some Systems

In WRR, WFQ or other weight-based algorithms, some systems assign packets to queues and calculate weights based on priority, performance requirements, scheduling groups or some combination thereof There are numerous deficiencies in these approaches.

For example, schedulers that consider performance requirements are typically complex to configure, requiring substantial network operator knowledge and skill, and may not be implemented sufficiently to distinguish data streams from differing applications. This leads to the undesirable grouping of both high and low importance data streams in a single queue or scheduling group. Consider, for example, an IEEE 802.16 network. An uplink (UL) data stream (or service flow) can be defined using a network's gateway IP address (i.e. IP “source address”). In such a case, all data streams “behind” the router, regardless of application or performance requirements are treated the same by the WiMAX UL scheduler policies and weights.

There are numerous potential deficiencies of a priority-based weighting system. The system used to assign priority may not be aware of the user application and in some cases cannot correctly distinguish among multiple data streams being transported to or from a specific user. The priority assignment is static and cannot be adjusted to account for changing network conditions. Priority information can be missing due to misconfiguration of network devices or even stripped due to network operator policy. The number of available priority levels can be limited, for example the IEEE 802.1p standard only allows 8 levels. In addition there can be mismatches due to translation discrepancies from one standard to another as packets are transported across a communication system.

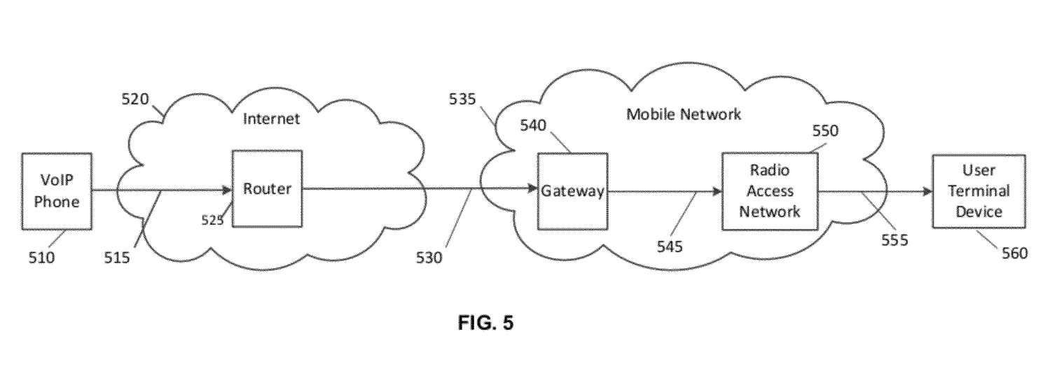

FIG. 5 is a block diagram illustrating a wireless communication system according to an embodiment. In the system illustrated in FIG. 5, a VoIP phone 510 is connected to the Internet 520 via communication link 515. Within the Internet 520 there exists one or more network routers 525 configured to direct traffic to the proper packet destination. In this example, Internet traffic is carried along link 530 into a mobile network 535. Traffic passes through a gateway 540 onto link 545 and into the Radio Access Network 550. The output of 550 is typically a wireless, radio-frequency connection 555 linked to a user terminal 560, such as a cell phone.

A discrepancy between two different priority systems can exist in the example illustrated in FIG. 5. For example, a VoIP phone will often be configured to use the IEEE 802.1p or IETF RFC 2474 (“diffserv”) packet marking prioritization system to mark packets with an elevated priority level indicating a certain level of desired treatment. Such priority levels fall into one of three categories: default, assured and expedited. Within the latter two categories, there are subcategories relating to the desired, relative performance requirements. Packets generated by the VoIP phone will thus travel on communication links 515 and 530 with such a priority marking. When the packets arrive at the mobile network gateway 540, these priorities need to be translated into the prioritization system established within the mobile network. For example, in an LTE network, mapping to QCI may be performed. This conversion may create problems. For example, the diffserv information may be completely ignored. Or the diffserv information may be used to assign a QCI level inappropriate for voice service. Additionally, the diffserv information may be used to assign a QCI level that is less fine-grained than the diffserv level, thus assigning the VoIP packets the same QCI level as packets from many other applications.

Some systems have combined the concepts of priority and performance requirements in an effort to provide additional information to the scheduling system. For example, in 802.16 the importance of streams (or “services”) is defined by a combination of priority value (based on packet markings such as 802.1p) and performance requirements. While a combined system such as 802.16 can provide the scheduler with a richer set of information, the deficiencies described above still apply.

The use of scheduling groups alone or in conjunction with the aforementioned techniques has numerous deficiencies in relation to end user QoE. For example, the available number of groups is limited in some systems which can prevent the fine-grained control necessary to deliver optimal QoE to each user. Additionally, some systems typically utilize a “best effort” group to describe those queues with the lowest importance. Data streams may fall into such a group because they are truly least important but also because such streams have not been correctly classified (intentionally or unintentionally), through the methods described above, as requiring higher importance.

An example of such a problem is the emergence of ‘over-the-top’ voice and video services. These services provide capability using servers and services outside of the network operator's visibility and/or control. For example, Skype and Netflix are two internet-based services or applications which support voice and video, respectively. Data streams from these applications can be carried by the data service provided by wireless carriers such as Verizon or AT&T, to whom they may appear as non-prioritized data rather than being identified as voice or video. As such, the packets generated by these applications, when transported through the wireless network, may be treated on a ‘best-effort’ basis with no priority given to them above typical best-effort services such as web browsing, email or social network updates.

Some systems implement dynamic adjustment of scheduling weights. For example, in order to meet performance requirements such as guaranteed bit rate (GBR) or maximum latency, scheduling weights may be adjusted upward for a particular data stream as its actual, scheduled throughput drops closer to the guaranteed minimum limit. However, this adjustment of weights does not take into account the effect of QoE on the end user. In the previous example, the increase of weight to meet GBR limit may result in no appreciable improvement in QoE, yet create a large reduction in QoE for a competing queue with lower weight.

Therefore, there is a need for a system and method to improve the differentiation of treatment of data packets streams from heterogeneous applications grouped into the same scheduling group, such as is common for a ‘best effort’ scheduling group. Additionally, there is a need to extend the information provided to a weight-based scheduler beyond priority and performance requirements in order to maximize user QoE across a network.

### Enhanced Classification Techniques

As described above, communication systems can use classification and queuing methods to differentiate data streams based on performance requirements, priority and logical connections.

To address previously noted deficiencies in some systems, the classification and queuing module 310 of FIG. 3 can be enhanced to provide an enhanced classification and queuing module 310. According to an embodiment, the functions illustrated in the weight-based scheduling system illustrated in FIG. 3 can be implemented in a single wireless or wireline network node, such as a base station, an LTE eNB, a UE, a terminal device, a network switch a network router, a gateway, or other network node (e.g., the macro base station 110, pico station 130, enterprise femtocell 140, enterprise gateway 103, residential femtocell 240, and cable modem or DSL modem 203 shown in FIGS. 1 and 2A). In other embodiments, the functions illustrated in FIG. 3 can be distributed across multiple network nodes. The enhanced classification and queuing module 310 can analyze the application class and/or the specific application of each packet and provide further differentiation of data packet streams grouped together by the traditional classification and queuing methods. The enhanced classification may be performed after the traditional classification as a separate step as shown in FIG. 4C, or may be merged into the traditional classification step as shown in FIG. 4B providing more detailed classification for use within scheduling groups.

Except as specifically noted, the elements of FIG. 4B operate as described with respect to FIG. 4A. However, the enhanced packet inspection module performs the enhanced packet inspection techniques described herein. As shown in FIG. 4B, in some embodiments, enhanced packet inspection module 410′ generates additional data queues 491′, 495′, and 495″.

Except as specifically noted, the elements of FIG. 4C operate as described with respect to FIG. 4A. In addition to the packet inspection module 410, an enhanced packet inspection module 410′ is provided. In one embodiment, the enhanced packet inspection module 410′ operates on data packets that have already been classified into different scheduling groups. While illustrated as separate modules, it will be appreciated that packet inspection module 410 and enhanced packet inspection module 410′ may be implemented as a single module. As shown, in some embodiments, enhanced packet inspection module 410′ generates additional data queues 491′, 495′, and 495″.

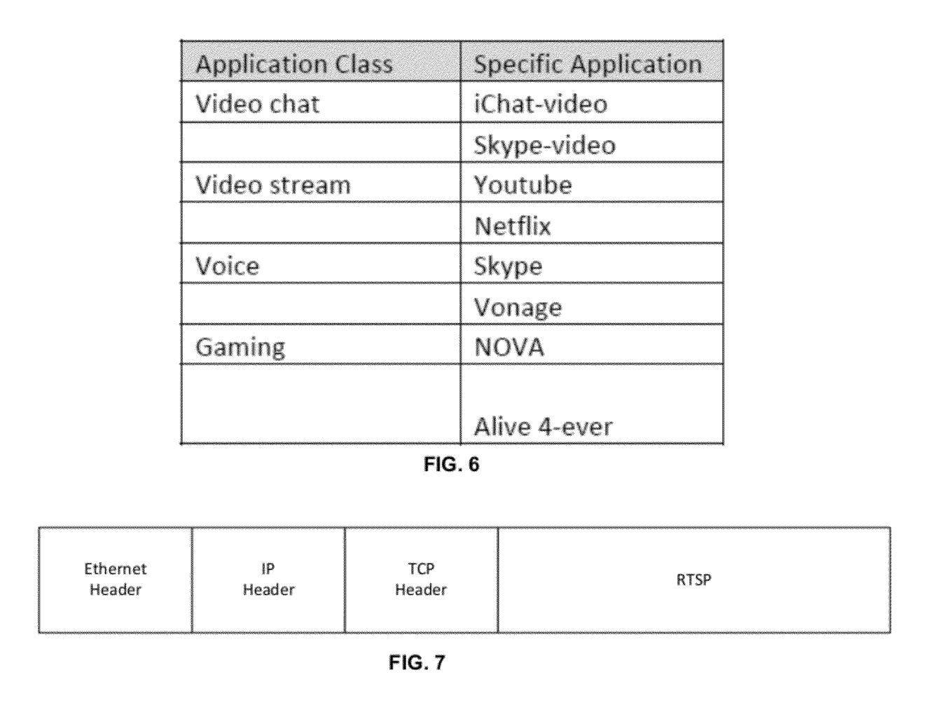

According to an embodiment, the enhanced classification steps disclosed herein can be implemented in the packet inspection module 410 of the enhanced classification and queuing module 310′. For example, 2-way video conferencing, unidirectional streaming video, online gaming and voice are examples of some different application classes. Specific applications refer to the actual software used to generate the data stream traveling between source and destination. Some examples include: YouTube, Netflix, Skype, and iChat. Each application class can have numerous, specific applications. The table provided in FIG. 6 illustrates some examples where an application class is mapped to specific applications.

According to an embodiment, the enhanced classification and queuing module 310 can inspect the IP source and destination addresses in order to determine the Application Class and Specific Application of the data stream. With the IP source and destination addresses, the enhanced classification and queuing module 310 can perform a reverse domain name system (DNS) lookup or Internet WHOIS query to establish the domain name and/or registered assignees sourcing or receiving the Internet-based traffic. The domain name and/or registered assignee information can then be used to establish both Application Class and Specific Application for the data stream based upon a priori knowledge of the domain or assignee's purpose. The Application Class and Specific Class information, once derived, can be stored for reuse. For example, if more than one user device accesses Netflix, the enhanced classification and queuing module 310 can be configured to cache the information so that the enhanced classification and queuing module 310 would not need to determine the Application Class and Specific Application for subsequent accesses to Netflix by the same user device or another user device on the network.

For example, if traffic with a particular IP address yielded a reverse DNS lookup or WHOIS query which including the name ‘Youtube’ then this traffic stream could be considered a unidirectional video stream (Application Class) using the Youtube service (Specific Application). According to an embodiment, a comprehensive mapping between domain names or assignees and Application Class and Specific Application can be maintained. In an embodiment, this mapping is periodically updated to ensure that the mapping remains up to date.

According to another embodiment, the enhanced classification and queuing module 310 is configured to inspect the headers, the payload fields, or both of data packets associated with various communications protocols and to map the values contained therein to a particular Application Class or Specific Application. For example, according to an embodiment, the enhanced classification and queuing module 310 is configured to inspect the Host field contained in an HTTP header. The Host field typically contains domain or assignee information which, as described in the embodiment above, is used to map the stream to a particular Application Class or Specific Application. For example an HTTP header field of “v11.lscache4.c.youtube.com” could be inspected by the Classifier and mapped to Application Class=video stream, Specific Application=Youtube.

According to another embodiment, the enhanced classification and queuing module 310 is configured to inspect the ‘Content Type’ field within a Hyper Text Transport Protocol (HTTP) packet. The content type field contains information regarding the type of payload, based upon the definitions specified in the Multipurpose Internet Mail Extensions (MIME) format as defined by the Internet Engineering Task Force (IETF). For example, the following MIME formats would indicate either a unicast or broadcast video packet stream: video/mp4, video/quicktime, video/x-ms-wm. In an embodiment, the enhanced classification and queuing module 310 is configured to map an HTTP packet to the video stream Application Class if the enhanced classification and queuing module 310 detects any of these MIME types within the HTTP packet.

In another embodiment, the enhanced classification and queuing module 310 is configured to inspect a protocol sent in advance of the data stream. For example, the enhanced classification and queuing module 310 is configured to identify the Application Class or Specific Type based on the protocol used to set up or establish a data stream instead of identifying this information using the protocol used to transport the data stream. According to an embodiment, the protocol sent in advance of the data stream is used to identify information on Application Class, Specific Application and characteristics that allow the transport data stream to be identified once initiated.

For example, in an embodiment, the enhanced classification and queuing module 310 is configured to inspect Real Time Streaming Protocol (RTSP) packets which can be used to establish multimedia streaming sessions. RTSP packets are encapsulated within TCP/IP frames and carried across an IP network, as shown for an Ethernet based system in FIG. 7.

The RTSP protocol includes a DESCRIBE function that is used to communicate the details of a multimedia session between Server and Client. This DESCRIBE request is based upon the Session Description Protocol (SDP defined in RFC 2327) which specifies the content and format of the requested information. With SDP, the m-field defines the media type, network port, protocol and format. For example, consider the following SDP media descriptions:
m=audio 49170 RTP/AVP 0
m=video 51372 RTP/AVP 31

In the first example, an audio stream is described using the Real-Time Protocol (RTP) for data transport on Port 49170 and based on the format described in the RTP Audio Video Profile (AVP) number 0. In the second example, a video stream is described using RTP for data transport on Port 51372 based on RTP Audio Video Profile (AVP) number 31.

In both RTSP examples, the m-fields are sufficient to classify a data stream to a particular Application Class. Classification to a Specific Application is not possible with this information alone. Since the m-fields call out communication protocol (RTP) and IP port number, the ensuing data stream(s) can be identified and mapped to the classification information just derived.

### Enhanced Queuing

According to an embodiment, enhanced classification and queuing module 310 can also be configured to implement enhanced queuing techniques. As described above, once enhanced classification has been completed, the enhanced classification and queuing module 310 can assign to an enhanced set of queues based on the additional information derived by the enhanced classification techniques described above. For example, in an embodiment, the packets can be assigned to a set of queues by: application class, specific application, individual data stream, or some combination thereof.

In one embodiment, enhanced classification and queuing module 310 is configured to use a scheduling group that includes unique queues for each application class. For example, an LTE eNB may assign all QCI=6 packets to a single scheduling group. But with enhanced queuing, packets within QCI=6 which have been classified as Video Chat may be assigned to one queue, while packets classified as Voice may be assigned to a different queue, allowing differentiation in scheduling.

In another alternative embodiment, the enhanced classification and queuing module 310 is configured to use a scheduling group that includes unique queues for each specific application. For example, an LTE eNB implementing enhanced queuing may assign QCI=9 packets classified as containing a Youtube streaming video to one scheduling queue, while packets classified as a Netflix streaming video to a different scheduling queue. Even though they are the same Application Class, the packets are assigned different queues in this embodiment because they are different Specific Applications.

In yet another embodiment, the enhanced classification and queuing module 310 is configured such that a scheduling group may consist of unique queues for each data stream. For example an LTE eNB may assign all QCI=9 packets to a single scheduling group. Based on enhanced classification methods described above, each data stream is assigned a unique queue. For example, consider an example embodiment with a scheduling group servicing 5 mobile phone users, each running 2 Specific Applications. In one embodiment, if the applications for each mobile device are mapped to the default radio bearer for the mobile this would result in 5 queues, one for each mobile, carrying heterogeneous data using the original classification and queuing module. However, in one embodiment, 10 queues are created by the enhanced classification and queuing module 310 in support of the 10 data streams. In an alternative example, each of the 5 mobiles has 2 data streams which use the same Specific Application. In this case, the data streams are also classified based on, for instance, port number or session ID into separate queues resulting in 10 queues.

One skilled in the art will recognize that the enhanced categorization and queuing techniques described above can be used to improve the queuing in a wireless or wired network communication system. One skilled in the art will also recognize that the techniques disclosed herein can be combined with other methods for assigning packets to queues to provide improved queuing.

### Application Factor

According to an embodiment, the enhanced weight calculation module 335 is configured to use enhanced policy information when calculating weights to address QoE deficiencies of some weighting techniques described above. According to an embodiment, the enhanced policy information 350 can include the assignment of a quantitative level of importance and relative priority based upon Application Class and Specific Application. This factor is referred to herein as the Application Factor (AF) and the purpose of the AF is to provide the operator with a means to adjust the relative importance, and ultimately the scheduling weight, of queues following enhanced classification and enhanced queuing. In another embodiment, AFs are established through the use of internal algorithms or defaults, requiring no operator involvement.

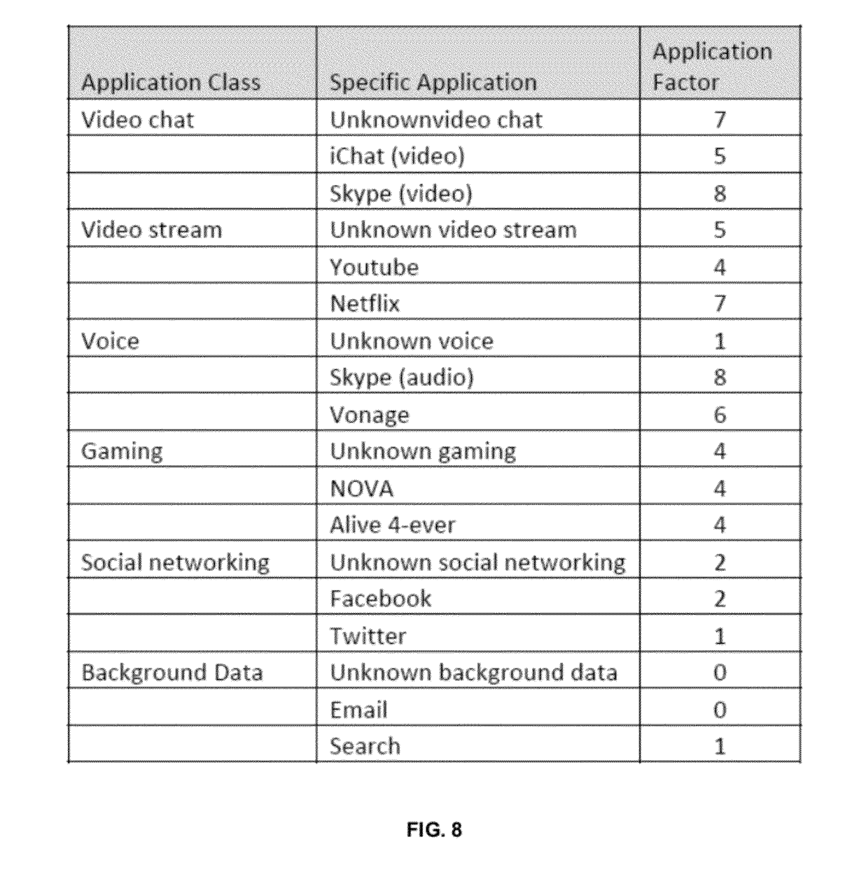

FIG. 8 is a table illustrating sample AF assignments on per Application Class and per Specific Application basis according to an embodiment. In cases where it is not possible to identify the Specific Application carried by a packet or data stream, an AF assignment can be made to an ‘unknown’ category within the Application Class. To optimize QoE for throughput and latency sensitive applications, video and voice applications have been assigned higher AF values (all but one is 6 or higher) over background data and social network traffic (AF in the range of 0-2).

Within the video chat class, the operator may discover that one video chat service (e.g., iChat) is substantially more burdensome (e.g., requires more capacity, has less latency or jitter tolerance) than another (e.g., Skype video), and can attempt to encourage the use of the more network friendly application by assigning a higher AF value to the Skype video chat than to iChat (8 versus 5).

Similarly, the operator may decide to preserve the QoE of a paid service, such as Netflix, at the expense of what may be considered the less important need to view short, free services, such as YouTube videos by adjusting the AF associated with these services. The operator may desire the ability to enhance certain voice services (e.g. Skype audio, Vonage) who have engaged strategically with the Operator with a high AF (8 and 6, respectively) while assigning all remaining (i.e. non-strategic) voice services a very low AF of 1.

One of ordinary skill in the art would understand that different AF values could be used to create different weight relationships between the application classes and specific applications. One skilled in the art would also understand how additional application classes and specific applications beyond those shown in FIG. 8 could be added.

Additionally, one of ordinary skill in the art would understand that AFs may be assigned differently based upon node type and/or node location. For example, an LTE eNB serving a suburban, residential area may be configured to use one set of AFs while an LTE eNB serving a freeway may be configured use a different set of AFs.

### Scheduling Weights

According to an embodiment, enhanced weight calculation module 335 can also be configured to implement enhanced techniques for determining weighting factors. As described above, some weighting algorithms can adjust scheduling weights for individual queues based on various inputs. For example, in the system illustrated in FIG. 3, the Weight calculation process module 335 can be configured to calculate the new weights based on a various inputs, including the classification information 330, optional operator policy and SLA information 350, and optional scheduler feedback information 345 (e.g., stream history received from scheduler module 320).

According to an embodiment, an enhanced weight calculation module 335 can use additional weighting factors to improve QoE performance. For example, in an embodiment, an additional weight factor can used to generate an enhanced weight (W′) as shown below:

W′(q)=a*W(q)+b*AF(q)

where:
W′=enhanced queue weight
q=the queue index
W=the queue weight derived by conventional weight calculations
a=coefficient mapping W to W′
AF=the Application Factor
b=coefficient mapping AF to W′

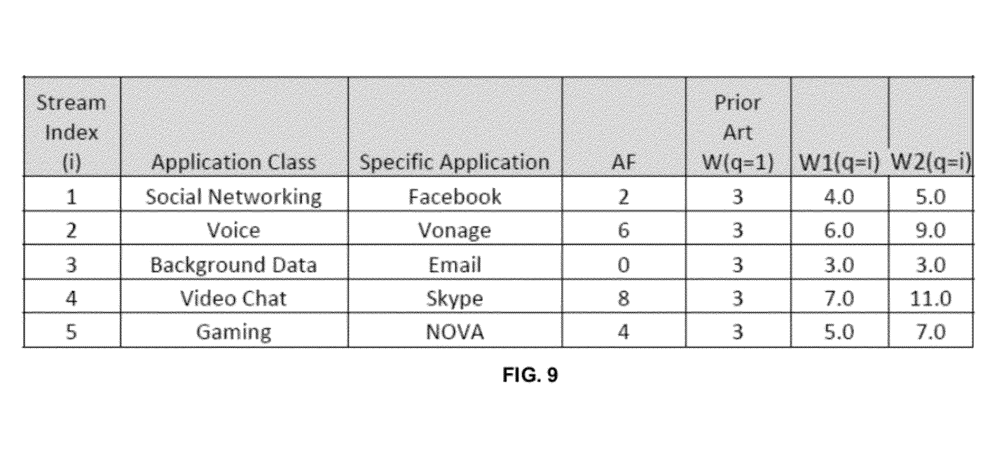

For example, in an embodiment, an LTE eNB base station with 5 active streams (designated by a stream index i) within a single queue, best effort scheduling group (e.g. QCI=9 in LTE), is shown in FIG. 9. Due to the deficiencies described in the conventional techniques, there are numerous Application Classes and Specific Applications assigned to a single queue in this scheduling group. In this example, all packets are assigned to the same queue resulting in no differentiation between Application Class and/or Specific Application by the scheduler.

For example, stream #1, a Facebook request, and stream #4, a Skype video chat session are both assigned to the same queue. Because packets from both streams are in the same queue, both streams must share the resources provided by the scheduler in a non-differentiated manner. For example, packets may be serviced in a FIFO method from the single queue thereby creating a “first to arrive” servicing of packets from both streams. This is undesirable during times of network congestion, due to the fact that a video chat session is more sensitive, in terms of user QoE, to packet delay or discard than a Facebook update.

In contrast, if the enhanced weight calculation technique described above (which can be implemented in enhanced weight calculation module 335) are applied, each of the five streams (designated by index i in FIG. 9) can be assigned to unique queues (designated by index q in FIG. 9). Each queue may then be assigned unique, enhanced weights as a function of Application Class and Specific Application. For example, the columns W1 and W2 in FIG. 9 demonstrate the results of enhanced queue weight calculations based on the Application Class, Specific Application and AF shown in FIG. 8, assuming each data stream i is assigned to a unique queue, q.

Weights W1 and W2 are calculated for each stream using the equation for W′ (described above) with coefficient ‘a’ set to 1, and coefficient ‘b’ set to 0.5 and 1, respectively. That is:

W1(q)=W(q)+0.5*AF(q)

W2(q)=W(q)+AF(q)

The effect of the calculation can be seen by again comparing data stream #1 with stream #4. For W1, the video chat stream has a weight of 7 which is now larger than the Facebook stream weight of 4. As coefficient ‘b’ is increased to 1.0 in the calculations of W2, the difference in weight between stream #4 and #1 increases further (11 and 5, respectively).

For cases W1 and W2, the Skype stream will be allocated more resources than the Facebook stream. This increases the likelihood that the Skype session will be favored by the scheduler and can improve session performance and QoE during times of network congestion. While this comes at the expense of the Facebook session, the tradeoff is asymmetrical: packet delay/discard will have a smaller effect (i.e. less noticeable) on the Facebook session as compared to the equivalent packet treatment for a video chat session. Therefore the application-aware scheduling system has provided a more optimal response with respect to end-user QoE.

In an alternative example, each data stream in FIG. 9 is for a different mobile and may already be in separate queues within the scheduling group for QCI 9. In some systems the weight assigned to each queue would not consider Specific Application or Application Class. However, as described herein, in some embodiments, the weights are differentiated.

One of ordinary skill in the art would also recognize that the systems and methods described above may be extended to cases for which a queue contains packets from more than one data stream, more than one Specific Application, more than one Application class or combinations thereof for which an aggregate scheduling may be appropriate. For example, an enhanced weight may be assigned to a queue containing three Skype/Video Chat data streams generated by three different mobile phones. Additionally, the systems and methods described above may be applied to all or only a subset of queues in one or more scheduling groups. For example, enhanced weighting and enhanced queuing may be applied to an LTE QCI=9 scheduling group but known weighting may be applied to LTE QCI=1-8 scheduling groups. Furthermore, the mapping of coefficients ‘a’ and ‘b’ may be adjusted as a function of scheduling group or alternative grouping of queues. For example, coefficient ‘b’ may be set to 1 for a scheduling group containing LTE QCI=9 queues but set to 0.5 for LTE QCI=8 queues.

### Time-Varying Application Factor

According to an embodiment, the enhanced weight calculation module 335 can also be configured to extend the application factor (AF) from a constant to one or more time-varying functions, AF(t). According to some embodiments, the AF is adjusted based upon a preset schedule. An operator may desire a particular treatment of applications at one time during the day and a differing treatment during other times.

For example, in one embodiment, the enhanced weight calculation module 335 is configured to use “rush hour” AF values during typical commute times where voice calls are the predominant application running on a mobile network, especially for those cells and sectors serving transportation routes. For such times, (e.g., Monday through Friday, 7 am to 9 am and 4 pm to 7 pm) all voice applications are assigned an AF=10 improving the level of service above all other applications (referencing FIG. 8). Outside of those time periods, the enhanced weight calculation module 335 is configured to revert to the regular AF values.

In another example, the enhanced weight calculation module 335 is configured to use larger AF values with over-the-top (OTT) video services during periods where such services are most likely to be used. For example, the enhanced weight calculation module 335 is configured to use larger AF values during evenings on weekends, especially for networks that service residential areas. Referring once again to FIG. 8, the peak settings for OTT video could include, for example, setting Video Stream applications (e g unknown video stream and Netflix) to an AF=10 between 7-11 pm on Friday and Saturday.

One of ordinary skill in the art would recognize that periodic, schedule based AF adjustments can be based on any recurring period including, but not limited to, time of day, day of week, tide, season and holidays. Furthermore, in an embodiment the enhanced weight calculation module 335 is configured to use non-recurring scheduling to adjust the AF in response to local sporting, business and community activities or other one-time scheduled events. According to some embodiments, the AF values can be manually configured by a network operator for non-recurring scheduling. According to other embodiments, the enhanced weight calculation module 335 is configured to access event information stored on the network (or in some embodiments pushed to the network node on which the enhanced weight calculation module 335 is implemented) and the enhanced weight calculation module 335 can automatically update the AF values according to the type of event. According to an embodiment, the enhanced weight calculation module 335 can also be configured to update the AF values in real-time to accommodate unforeseen events including changing weather patterns, natural or other disasters or law enforcement/military activity.

### Duration Neglect and Recency Effects

A further method to enhance the weight function extends the mapping coefficient, b, to a time varying function, assigned on a per queue basis. That is, b is a function of both time (t) and queue (q), b(q,t). In one embodiment, b(q,t) is adjusted in real-time, in response to, or in advance of, scheduler decisions for streams carrying video data streams (streaming or two-way) each on unique queues. This embodiment can further reduce peak load with minimal QoE loss by taking advantage of both the recency effect (RE) and duration neglect (DN) concepts as described by Aldridge et al. and Hands et al. See Aldridge, R.; Davidoff, J.; Ghanbari, M.; Hands, D.; Pearson, D., “Recency effect in the subjective assessment of digitally-coded television pictures,” Image Processing and its Applications, 1995., Fifth International Conference on, vol., no., pp. 336-339, 4-6 Jul. 1995, and Hands, D. S.; Avons, S. E.: Recency and duration neglect in subjective assessment of television picture quality. Journal of Applied Cognitive Psychology, vol. 15, no. 6, pp. 639-657, 2001, which are both incorporated by reference as if set forth in full herein.

The concept of DN is that the duration of an impairment viewed during video playback is less important than its severity. Thus for video being transported across a multiuser, capacity constrained network, it may be preferred (from a QoE perspective) for a scheduler which has already dropped one or more video packets from a video stream to continue to drop packets from that stream, rather than choose to drop packets from an alternate video stream, so long as the packet loss rate does not exceed a preset threshold. For example, based on the DN concept, discarding 5% of the packets of a single video stream over 10 seconds provides improved network QoE as compared to discarding 5% of the packets for 2 seconds, for each of 5 different video streams.

The concept of RE is that viewers of a video playback tend to forget video impairments after a certain amount of time and therefore judge video quality based on the most recent period of viewing. For example, a viewer may subjectively judge a video playback to be “poor” if the video had frozen (i.e. stopped playback) for a period of 2 seconds within the last 15 seconds of a video clip and judge playback to be “average” if the same 2 second impairment occurred 1 minute from the end of the video clip.

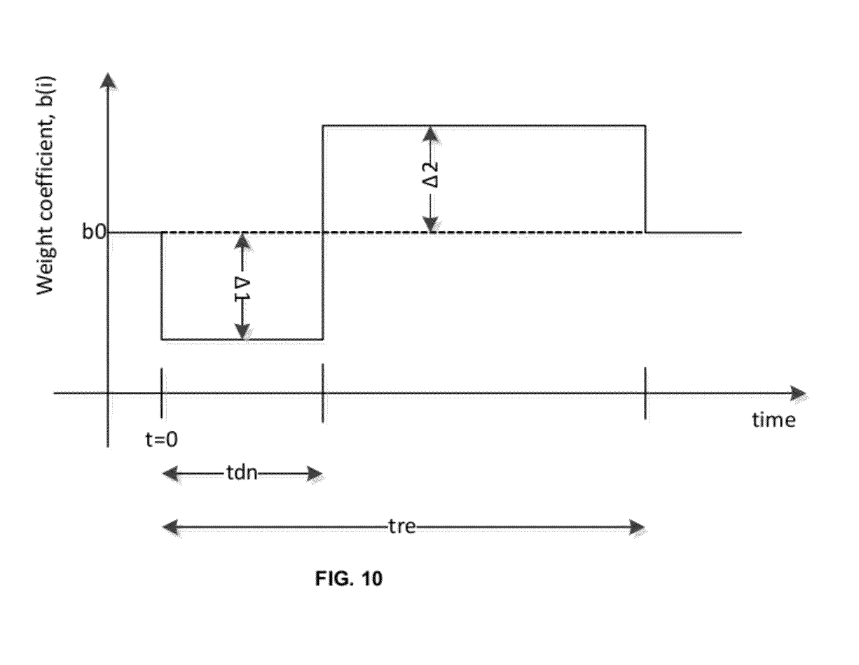

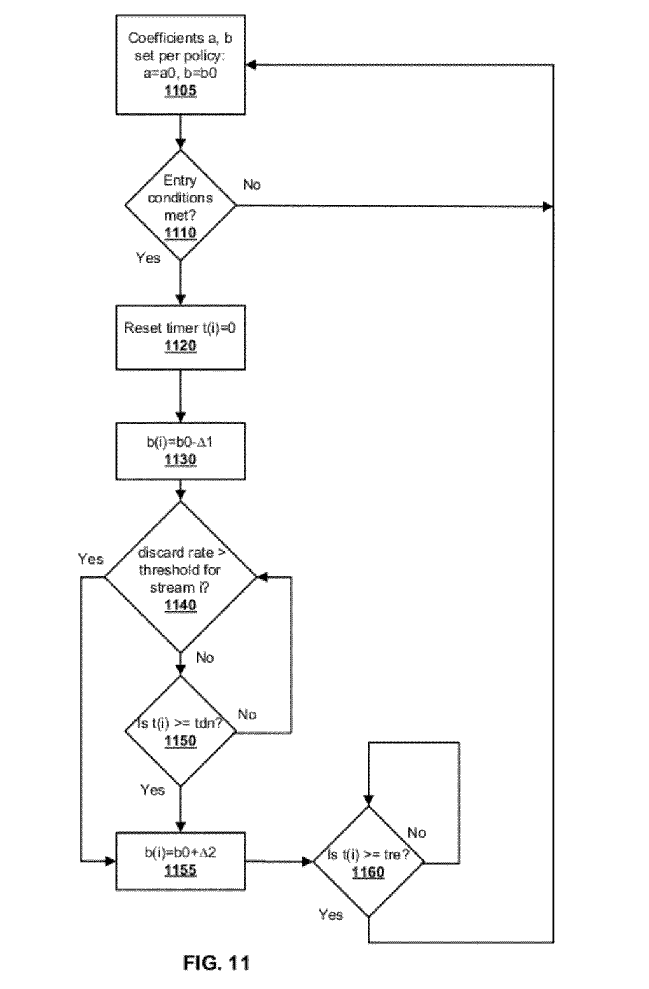

To this end, the coefficient ‘b’ is managed, on a per queue (and in this case a per data stream) basis, using the timing diagram shown in FIG. 10 and the method illustrated in FIG. 11. Per the concept of DN, a video stream that has undergone packet loss can “tolerate” additional, modest packet loss (or some other evaluation metric) without a substantial degradation of user QoE. This extension of degradation relieves some, potentially all, of the network congestion and thus benefits the remaining user streams which can be serviced without degradation. Following a period of degradation, a video stream is serviced with increased performance for a period of time, per the concept of RE.

As shown in FIG. 10, during the period of intentional degradation, the value of b(i) is adjusted from its nominal value of b0 downward by an amount Δ1, for a period of tdn. This is followed by a period of enhancement in which b(i) is increased byΔ2 above b0 (Δ2 could be 0). This enhancement period lasts for the remainder of the period tre after which the coefficient b(i) returns to its normal value=b0.

FIG. 11 illustrates a method for assigning weights to queues in a scheduling system according to an embodiment. In an embodiment, the method illustrated in FIG. 11 is implemented in weight calculation module 335.

The method illustrated in FIG. 11, begins with coefficients a and b of the enhanced weight equation being set per policy to a0 and b0, respectively (step 1105). One or more algorithm entry conditions are then evaluated (step 1110). In one embodiment, the algorithm entry condition is a signal from the scheduler that video stream i must initiate the algorithm due to current or predicted levels of congestion in the network. In an alternative embodiment, the entry condition is based on detection of one or more dropped or delayed packets by the scheduler from video stream i. One of ordinary skill in the art will recognize that additional entry conditions can be created using various combinations of scheduler and classifier information. One of ordinary skill in the art will further recognize that entry conditions can be based upon meeting one or more criteria be based on various forms of information including triggers, alarms, thresholds, or other methods.

Once the entry condition or conditions have been met, a two-stage timing algorithm is initiated. A stream time is reset to zero (step 1120) and the value of b(i) is reduced by an amount Δ1 (step 1130).

A determination is then made whether the current frame discard rate exceeds a threshold for stream i (step 1140). For example, in an embodiment, the threshold is set to 5% over a 1 second period. In other embodiments, a different threshold can be set up for the stream based on the desired performance characteristics for that stream.

If the frame discard rate for the stream exceeds the threshold, the intentional degradation phase is terminated and the method continues with step 1155. Otherwise, if the frame discard rate does not exceed the threshold, a determination is made whether the timer has reached tdn. If the timer has reached or passed tdn, the intentional degradation phase is terminated and method continues with step 1155. Otherwise, if tdn has not been reached, the method returns to step 1140 where the a determination is again made whether the current frame discard rate exceeds a threshold for stream i.

The coefficient b(i) is set to a value of bo+Δ2 (step 1155) before the timer is once again checked. A determination is then made whether the timer has reached tre (step 1160). If tre has not yet been reached, the method returns to step 1160. Otherwise, if the timer has reached tre, the method returns to step 1105.

According to an alternative embodiment, iteration through step 1160 can gradually adjust Δ2 towards zero over time period tre. According to another alternative embodiment, alternative (or additional) metrics such as packet latency, jitter, a predicted video quality score (such as VMOS) or some combination thereof is evaluated in step 1140. In a further embodiment, step 1140 is adjusted so that if the evaluation metric exceeds the threshold, the value Δ1 is reduced by an amount Δ3 with control then passing to step 1150 (rather than to step 1155).

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a unit, module, block or step is for ease of description. Specific functions or steps can be moved from one unit, module or block without departing from the invention.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

1. A weight-based scheduling system for scheduling transmission of data packets in a wireless communication system, the system comprising:
a classification and queuing module configured to receive input traffic that includes data from a plurality of heterogeneous data streams, the classification and queuing module being configured to analyze each packet and assign the packet to a scheduling group based on attributes of the packet and to a data queue of the scheduling group based on an Application Class or Specific Application of the data packet, the classification and queuing module being further configured to output one or more data queues and classification information associated with the data packets in each of the one or more data queues;
a weight calculation module configured to receive the classification information from the classification and queuing module and to calculate weights for each of the one or more data queues and to output the calculated weights; and
a scheduler module configured to select data packets from the one or more data queues in an order taking into account the calculated weights and to insert the selected data packets into an output queue for transmission over a physical communication layer.

2. The system of claim 1 wherein the scheduler module is further configured to receive an operator policy and service level agreement (SLA) information and to base the calculated weights at least in part on the operator policy and SLA information.

3. The system of claim 1 wherein the weight calculation module is further configured to receive scheduler feedback information from the weight calculation module, and wherein the weight calculation module is further configured to base the calculated weights at least in part on the scheduler feedback information.

4. The system of claim 1 wherein the classification and queuing module is configured to inspect at least one of the Internet Protocol (IP) source and destination addresses of the data packets in order to determine an Application Class or Specific Application associated with the data packets.

5. The system of claim 4 wherein the classification and queuing module is configured to query a network domain information source to collect information about the at least one of the IP source and IP destination addresses.

6. The system of claim 5 wherein the classification and queuing module is configured to perform a reverse domain name system (DNS) lookup to collect information about the at least one of the IP source and IP destination addresses.

7. The system of claim 5 wherein the classification and queuing module is configured to perform a WHOIS query to collect information about the at least one of the IP source and IP destination addresses.

8. The system of claim 5 wherein the classification and queuing module is configured to cache the collected information about the at least one of the IP source and IP destination addresses and to use the cached information to identify the Application Class or the Specific Application associated with the at least one of the IP source and IP destination addresses.

9. The system of claim 8 wherein the classification and queuing module is configured to maintain an association mapping IP source and destination addresses to an Application Class and/or a Specific Application.

10. The system of claim 9 wherein the classification and queuing module is configured to inspect at least one of a header and a payload field of a data packet to identify IP source and destination addresses associated with the data packet and to map the IP source and destination addresses to an Application Class or a Specific Application associated with the data packet.

11. The system of claim 9 wherein the classification and queuing module is configured to inspect a content type field associated with each data packet to identify a type of payload of the data packet and to map the type of payload to an Application Class or a Specific Application associated with the data packet.

12. The system of claim 11 wherein each data packet is configured according to the HTTP, MIME, RTP, or RTSP standard.

13. The system of claim 1 wherein the classification and queuing module is configured to inspect a protocol sent in advance of a data stream and to associate a an Application Class and a Specific Application with the data stream based on the protocol.

14. The system of claim 1, wherein the classification information includes the Application Class or Specific Application for data packets in the one or more data queues.

15. The system of claim 1 wherein the weight calculation module is further configured to obtain a default operator policy and service level agreement (SLA) information and to base the calculated weights at least in part on the operator policy and SLA information.

16. A method for prioritizing and scheduling data packets in a communication network, the method comprising:
receiving a plurality of data packets;
classifying the plurality of data packets;
segregating the plurality of data packets into a plurality of scheduling groups taking into account the classifying;
segregating the plurality of data packets within at least one of the plurality of scheduling groups into a plurality of queues taking into account application type or specific application;
determining weights to associate with each of the queues within at least one of the scheduling groups, the weights being determined at least in part by application types associated with the data packets; and
selecting data packets from the plurality of queues based on the weights associated with the queue;
inserting the selected packets into an output data queue based on the weight associated with each of the queues; and
transmitting the plurality of data packets across a physical communication layer for transmission across a network communication medium.

17. The method of claim 16, further comprising:
associating an Application Factor with each of plurality of user applications, wherein each Application Factor comprises a value associated with a network application that is used to indicate the relative importance of each of the user applications, the relative importance of each user application being used to determine a relative weight to be associated with data packets associated with the user application.

18. The method of claim 17 wherein the Application Factor associated with at least one of the user applications is dynamically adjustable.

19. The method of claim 18 wherein the Application Factor associated with the at least one of the user applications is dynamically adjusted on a recurring basis.

20. The method of claim 18 wherein the Application Factor associated with the at least one of the user applications is dynamically adjusted in response to a one-time network event.

21. The method of claim 17 wherein determining a weight to associate with each of the data queues further comprises calculating an enhanced weight for the data queue that is based at least in part on the Application Factor associated with the data packets included in the data queues.

22. The method of claim 16, wherein determining a weight comprises lowering a weight associated with a particular data queue from a first level to a second level lower than the first level for a first period of time.

23. The method of claim 22, wherein lowering the weight is performed responsive to detecting a dropped packet.

24. The method of claim 22, wherein lowering the weight is performed responsive to a current or anticipated congestion level.

25. The method of claim 22, wherein the first period of time is a fixed amount of time.

26. The method of claim 22, wherein the first period corresponds to an amount of time between lowering the weight and when a threshold for a frame discard rate is exceeded.

27. The method of claim of claim 22, further comprising:
after the first period of time, raising the weight from the second level to a third level higher than the first level for a second period of time; and
after the second period of time, lowering the weight from the third level to the first level.

28. The system of claim 4 wherein the classification and queuing module is configured to inspect at least one of a header and a payload field of a data packet to identify a name of a service provider in a uniform resource locator and to map the name of the service provider to an Application Class or a Specific Application associated with the data packet.
